(19) United States
(12) Patent Application Publication
(10) Pub. No.: US 2014/0304131 A1
(43) Pub. Date: Oct. 9, 2014

(54) SYSTEM FOR AND METHOD FOR DETERMINING OVERDRAFT PROTECTION

(71) Applicant: Capital One Financial Corporation, McLean, VA (US)

(72) Inventors: Gora GANGOPADHYAY, Ashburn, VA (US); Thomas STANMEYER, Vienna, VA (US); Caroline K. PEANI, Vashon, WA (US); Jing ZHANG, Herndon, VA (US); Michael F. RYDZY, Chadds Ford, PA (US); Chun-Hao MU, Arlington, VA (US); Chris GOUKER, Midlothian, VA (US); Karan CHOPRA, Glen Allen, VA (US); Christopher M. GRADNEY, New Orleans, LA (US); Dennis E. MILLER, Olney, MD (US); Thomas J. BANHOLZER, Glen Allen, VA (US); Scott J. SCHENKEIN, Midlothian, VA (US); Pamela W. WINKS, Fairfax, VA (US); Frann E. BURT, Upper Marlboro, MD (US); George MATTHEW, Weatogue, CT (US); Liang LI, McLean, VA (US)

(73) Assignee: Capital One Financial Corporation, McLean, VA (US)

(21) Appl. No.: 14/217,813

(22) Filed: Mar. 18, 2014

Related U.S. Application Data
(60) Provisional application No. 61/789,241, filed on Mar. 15, 2013.

(51) Int. Cl. G06Q 40/02

(52) U.S. Cl. CPC G06Q 40/02
USPC 705/35

(57) ABSTRACT

A system and method in accordance with example embodiments may calculate a velocity of money associated with a particular account and a particular customer. Additionally, a system and method in accordance with example embodiments may calculate an overdraft risk score based on the velocity of money, where the overdraft risk score may be used to determine an overdraft protection limit for an account.

### CROSS-REFERENCE TO RELATED APPLICATIONS

This application claims priority to U.S. Provisional Patent Application No. 61/789,241, filed on Mar. 15, 2013, the entire contents of which is incorporated herein by reference.

As described herein below, this application contains subject matter related to U.S. patent application Ser. No. ______, entitled “A System and Method For Processing Vector Exceptions”, filed on ______, the entire contents of which is incorporated herein by reference.

### FIELD OF DISCLOSURE

The present disclosure relates to systems and methods for determining overdraft protection based on an internally determined risk score.

### BACKGROUND INFORMATION

Financial institutions may provide an overdraft protection for accounts held at the financial institution. The overdraft protection may be determined and supplied by a third party vendor. Because a third party vendor is used, customer level characteristics are not used in the determination of an overdraft protection. Moreover, because the financial institution for which the overdraft protection is available is not knowledgeable about the logic behind assigning overdraft protection, the types of data provided are not evaluated for optimal overdraft protection determinations. Additionally, given the lack of transparency between a financial institution and a third party vendor, significant losses may be incurred in providing overdraft protection based on a limited set of information and where there is no feedback on the data that is used by the third party vendor. These and other drawbacks exist.

### SUMMARY OF THE DISCLOSURE

A system and method in accordance with example embodiments may calculate a velocity of money associated with a particular account and a particular customer. Additionally, a system and method in accordance with example embodiments may calculate an overdraft risk score based on the velocity of money, where the overdraft risk score may be used to determine an overdraft protection limit for an account.

An example system may include a receiver that receives, via a network, financial account data and customer data associated with a customer, a first database that stores the financial account data and the customer data, a velocity of money processor that calculates a velocity of money score for the customer using the account data and customer data, a risk processor that calculates an overdraft risk for the customer based on the account data, the customer data, and the velocity of money score, an account module that associates an overdraft protection limit based on the overdraft risk with an account of the customer, and a second database that stores the overdraft protection limit.

An example method may include receiving, via a network financial account data and customer data associated with a customer, storing the financial account data and the customer data in a first database, calculating, using a velocity of money processor, a velocity of money score for the customer using the account data and customer data, calculating, using a risk processor, an overdraft risk for the customer based on the account data, the customer data, and the velocity of money score, associating in an account module an overdraft protection limit based on the overdraft risk with an account of the customer; and storing the overdraft protection limit in a second database.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 is a schematic diagram illustrating a system for determining overdraft protection according to example embodiments;

FIG. 2 is a schematic diagram illustrating an example point of sale system that may be utilized in a system for determining overdraft protection according to example embodiments;

FIG. 3 is a block diagram of a hardware components of a system for determining overdraft protection according to example embodiments;

FIG. 4 is a schematic diagram illustrating a system for determining overdraft protection according to example embodiments;

FIG. 5 is a flowchart illustrating a method for determining and assigning an overdraft protection to a customer according to example embodiments; and

FIG. 6 is a schematic diagram illustrating a system for assigning overdraft limits.

### DETAILED DESCRIPTION OF PREFERRED EMBODIMENTS

The following description is intended to convey a thorough understanding of the embodiments described by providing a number of specific example embodiments and details involving systems and methods for determining and providing overdraft protection for a customer. It should be appreciated, however, that the present disclosure is not limited to these specific embodiments and details, which are examples. It is further understood that one possessing ordinary skill in the art, in light of known systems and methods, would appreciate the use of the invention for its intended purposes and benefits in various embodiments, depending on specific design and other needs. A financial institution and system supporting a financial institution as used as examples for the disclosure. The disclosure is not intended to be limited to financial institutions only.

According to various embodiments of the present disclosure, systems and methods enable determining and providing overdraft protection to a customer. Overdraft protection may come into effect when a customer uses an account to make a payment, but does not have the required funds available in the account to cover the payment amount. The overdraft protection may cover the difference in funds between the payment amount and then account balance if the difference is less than an overdraft protection limit associated with the account. When overdraft protection is used, a customer may incur a fee that the bank may collect once a customer replenishes the account with the appropriate funds. Overdraft protection may be used in various situations. For example, a customer that maintains an account with the financial institution may write a check with the mistaken assumption that the account linked to the check has enough funds to cover the value written on the check. As another example, a customer that maintains an account with a financial institution may make a payment using an account the customer knows does not have the funding to cover the payment. However, the customer may know that a payment will be credited to his or her account the following day that will cover the difference between the payment amount and the available account funds as well as the fee incurred by using overdraft protection. While account information may assist in determining a risk score associated with a customer in either situation, including customer data, such as a determined velocity of money that looks at transaction and deposit patterns, may optimize overdraft protection revenues while minimizing losses associated with providing overdraft protection.

In an example embodiment, a customer may be a customer of a financial institution where the customer maintains an account. The financial institution may maintain customer data as well as account data, where the account data may be linked to the customer data. Account data may include any, or a combination, of account type, account balance, account transaction details, and/or account debits and credits. Customer data may include any, or a combination, of customer name, customer address, customer date of birth, customer social security number, customer employment status, customer employer name, customer income, customer residential status (e.g., whether a customer rents or owns), customer monthly mortgage or rental payments, customer marital status, and/or customer velocity of money rating. A customer velocity of money rating may be determined based on a statistical analysis of customer transaction and deposit patterns associated with an account. For example, where a customer transaction pattern is to spend deposited money the day after making a deposit, a customer may have a high velocity of money rating. If a customer transaction pattern is to incur transactions at a steady rate following a deposit, a customer may have a low velocity of money rating. Transaction data from the various transactions performed by the customer may be used in determining a velocity of money rating and/or score. For example, the transaction date, amount, type (e.g., card present, online or e-commerce, debit, credit, and/or the like), and other like transaction data may be analyzed using various analysis processors against and/or along with the deposit data to determine a velocity of money rating/score. As discussed above, the velocity of money may be a sliding scale based on how fast the user spends money relative to the deposits (e.g., immediate spend may result in a high velocity of money and a slower, more patterned spend may result in a lower velocity of money). The velocity of money rating/score also may exist on other statistical model and/or analytical models. Modules may include hardware and software.

In an example embodiment, the financial institution may also contain various modules to assist in calculating a risk score that may be used in determining an overdraft protection limit for a customer. As used herein, the term “module” may be understood to refer to computer executable software, firmware, hardware, or various combinations thereof. It is noted that the modules shown and described herein are intended as examples. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

In an example embodiment, the financial institution system may include a risk module that calculates an overdraft risk score associated with a particular account held by a particular customer. The overdraft risk score may be calculated based on the customer data and the account data, taking into account the velocity of money score associated with the customer. Moreover, the financial institution system may include an overdraft module that determines an overdraft protection limit to associate with the calculated risk score of a customer account. Also, an overdraft module may reside or be accessible at a third party system that receives the calculated risk score from the financial institution system. The third party system overdraft module may then return the overdraft protection limit associated with a particular risk score to the financial institution. The financial institution may also include an account module that links an overdraft protection limit to the account once an overdraft protection limit has been determined.

In an example embodiment, a financial institution may calculate, on a predetermined schedule, an overdraft risk score for a particular account associated with a customer. A predetermined schedule may be, for example, on a daily basis, on a weekly basis, on a monthly basis. In an example embodiment, a financial institution may calculate an overdraft risk score for a particular account associated with a customer when a trigger signal is received. A trigger signal may be, for example, the modification of customer data within the financial institution data storage and/or system, the modification of account data within the financial institution data storage and/or system, and/or the addition or deletion of an account associated with a customer within the financial institution data storage and/or system.

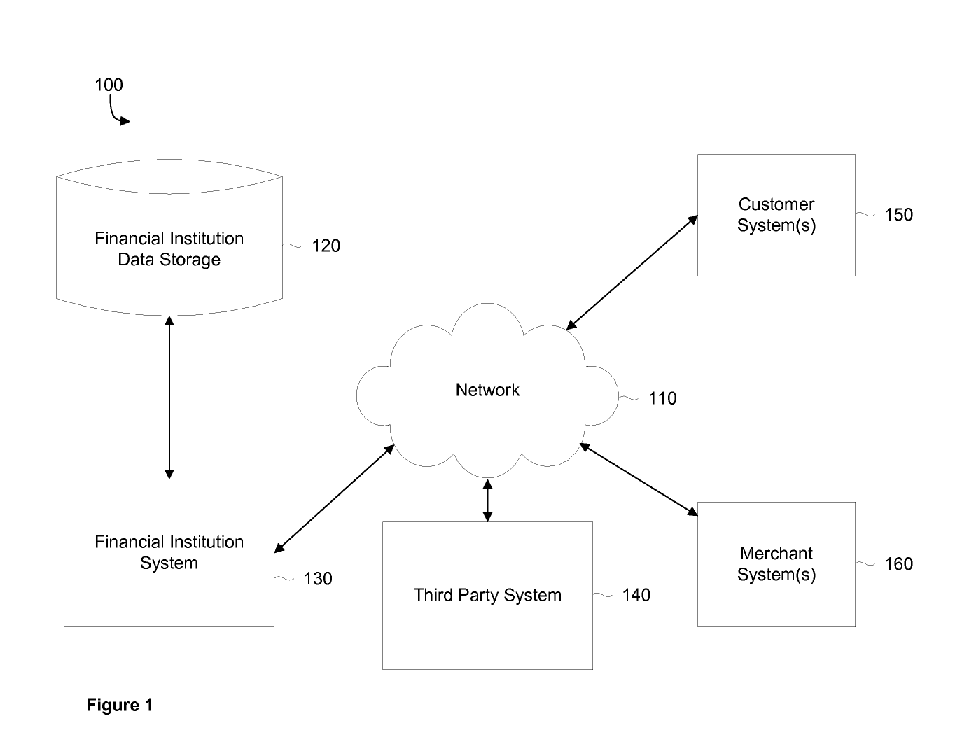

FIG. 1 depicts an example system 100 for use with an overdraft protection limit determination. System 100 may include merchant system(s) 160, customer system(s) 150, a financial institution system 130, a financial institution data storage 120, and a third party system 140, all connected over a network 110. For example, network 110 may be one or more of a wireless network, a wired network or any combination of wireless network and wired network. For example, network 110 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 110 may include, without limitation, telephone lines, fiber optics, IEEE Ethernet 902.3, a wide area network (“WAN”), a local area network (“LAN”), or a global network such as the Internet. Also network 110 may support an Internet network, a wireless communication network, a cellular network, or the like, or any combination thereof. Network 110 may further include one network, or any number of the example types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

Merchant system(s) 160, customer system(s) 150, third party system 140, and financial institution system 130 may each include a network-enabled computer system and/or device. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The network-enabled computer systems may further include data storage. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

Merchant system(s) 160 may include a system attempting to receive funding from a customer account. Merchant system(s) 160 may include, for example, other customer system(s), where a second customer is behaving as a merchant; a system associated with a merchant where a customer is attempting to make a purchase or pay a bill; and/or a system associated with a creditor where a customer is attempting to pay a creditor bill. Accordingly, customer system(s) 150 may include a system for transferring funds to merchant system(s) 160 and/or other customer system(s) 150.

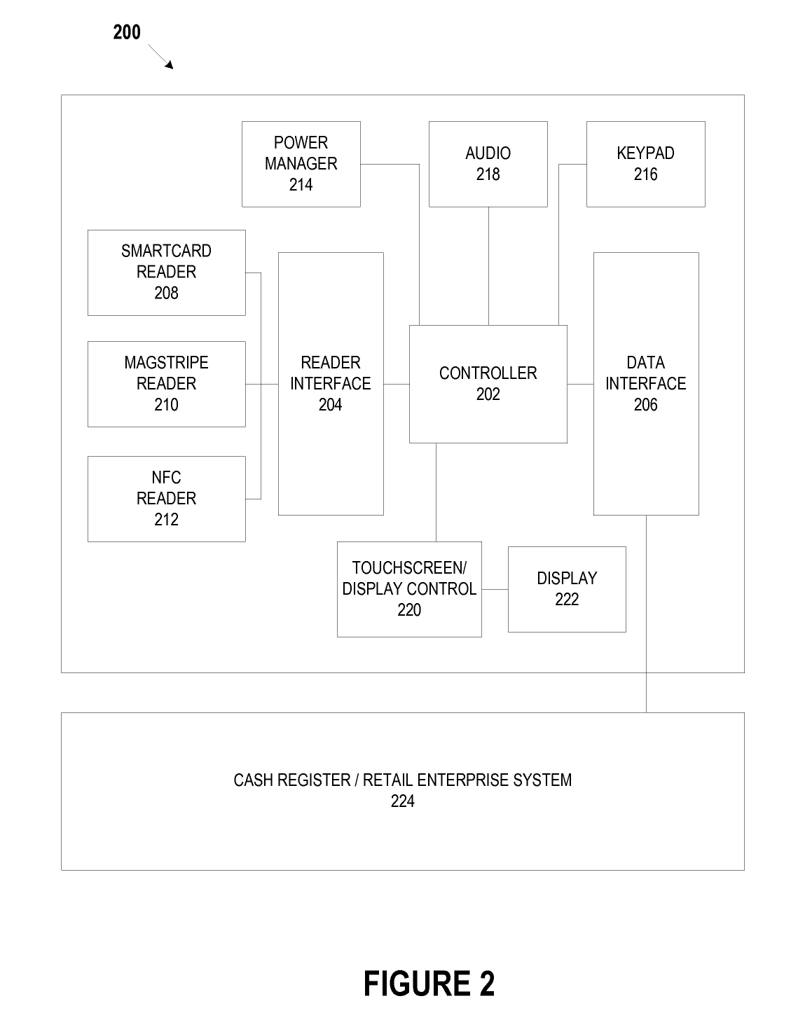

Merchant system(s) 160 may include a point of sale system that may request authorization for a transaction that initiates, for example, an overdraft. FIG. 2 depicts an example Point of Sale (PoS) device 200. PoS device 200 may provide the interface at what a customer or end user makes a payment to the merchant in exchange for goods or services. PoS device 200 may include and/or cooperate with weighing scales, scanners, electronic and manual cash registers, electronic funds transfer at point of sale (EFTPOS) terminals, touch screens and any other wide variety of hardware and software available for use with PoS device 200. PoS device 200 may be a retail point of sale system and may include a cash register and/or cash register-like computer components to enable purchase transactions. PoS device 200 also may be a hospitality point of sale system and include computerized systems incorporating registers, computers and peripheral equipment, usually on a computer network to be used in restaurant, hair salons, hotels or the like. PoS device 200 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 200 also may be a cloud-based point of sale system that can be deployed as software as a service, which can be accessed directly from the Internet using, for example, an Internet browser.

Referring to FIG. 2, an example PoS device 200 is shown. PoS device 200 may include a controller 202, a reader interface 204, a data interface 206, a smartcard reader 208, a magnetic stripe reader 210, a near-field communications (NFC) reader 212, a power manager 214, a keypad 216, an audio interface 218, a touchscreen/display controller 220, and a display 222. Also, PoS device 200 may be coupled with, integrated into or otherwise connected with a cash register/retail enterprise system 224.

In various embodiments, controller 202 may be any controller or processor capable of controlling the operations of PoS device 200. For example, controller 202 may be a Intel® 2nd Generation Core™ i3 or i5 or Pentium™ G850 processor or the like. Controller 202 also may be a controller included in a personal computer, smartphone device, tablet PC or the like.

Reader interface 204 may provide an interface between the various reader devices associated with PoS device 200 and PoS device 200. For example, reader interface 204 may provide an interface between smartcard reader 208, magnetic stripe reader 210, NFC reader 212 and controller 202. In various embodiments, reader interface 204 may be a wired interface such as a USB, RS222 or RS485 interface and the like. Reader interface 204 also may be a wireless interface and implement technologies such as Bluetooth, the 802.11(x) wireless specifications and the like. Reader interface 204 may enable communication of information read by the various reader devices from the various reader devices to PoS device 200 to enable transactions. For example, reader interface 204 may enable communication of a credit or debit card number read by a reader device from that device to PoS device 200. In various embodiments, reader interface 204 may interface between PoS device 200 and other devices that do not necessarily “read” information but instead receive information from other devices.

Data interface 206 may allow PoS device 200 to pass communicate data throughout PoS device and with other devices including, for example, cash register/retail enterprise system 224. Data interface 206 may enable PoS device 200 to integrate with various customer resource management (CRM) and/or enterprise resource management (ERP) systems. Data interface 206 may include hardware, firmware and software that make aspects of data interface 206 a wired interface. Data interface 206 also may include hardware, firmware and software that make aspects of data interface 206 a wireless interface. In various embodiments, data interface 206 also enables communication between PoS device other devices.

Smartcard reader 208 may be any electronic data input device that reads data from a smart card. Smartcard reader 208 may be capable of supplying an integrated circuit on the smart card with electricity and communicating with the smart card via protocols, thereby enabling read and write functions. In various embodiments, smartcard reader 208 may enable reading from contact or contactless smart cards. Smartcard reader 208 also may communicate using standard protocols including ISO/IEC 7816, ISO/IEC 14443 and/or the like or proprietary protocols.

Magnetic stripe reader 210 may be any electronic data input device that reads data from a magnetic stripe on a credit or debit card, for example. In various embodiments, magnetic stripe reader 210 may include a magnetic reading head capable of reading information from a magnetic stripe. Magnetic stripe reader 210 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments. Track 3 transmission channels also may be used to transmit, for example, geolocation data associated with a user, product data relating to the purchase (e.g., product information, stock keeping unit (SKU) level data, and/or any other information that may be used to provide purchase-driven smart statements. PoS device 200 may communicate and or cooperate with the user device to provide the information into track 3 transmission channels. Other methods for providing product level data to a financial institution. For example, a merchant can transmit the product data for each transaction to a financial institution along with information that identifies the transaction.

NFC reader 212 may be any electronic data input device that reads data from a NFC device. In an exemplary embodiment, NFC reader 212 may enable Industry Standard NFC Payment Transmission. For example, the NFC reader 212 may communicate with a NFC enabled device to enable two loop antennas to form an air-core transformer when placed near one another by using magnetic induction. NFC reader 212 may operate at 13.56 MHz or any other acceptable frequency. Also, NFC reader 212 may enable a passive communication mode, where an initiator device provides a carrier field, permitting answers by the target device via modulation of existing fields. Additionally, NFC reader 212 also may enable an active communication mode by allowing alternate field generation by the initiator and target devices.

In various embodiments, NFC reader 212 may deactivate an RF field while awaiting data. NFC reader 212 may receive communications containing Miller-type coding with varying modulations, including 100% modulation. NFC reader 212 also may receive communications containing Manchester coding with varying modulations, including a modulation ratio of approximately 10%, for example. Additionally, NFC reader 212 may be capable of receiving and transmitting data at the same time, as well as checking for potential collisions when the transmitted signal and received signal frequencies differ.

NFC reader 212 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 212 may be able to utilize transmission protocols and methods that are developed in the future using other frequencies or modes of transmission. NFC reader 212 also may be backwards-compatible with existing payment techniques, such as, for example RFID. Also, NFC reader 212 may support transmission requirements to meet new and evolving payment standards including internet based transmission triggered by NFC. In various embodiments, NFC reader 212 may utilize MasterCard's® PayPass and/or Visa's® PayWave and/or American Express'® ExpressPay systems to enable transactions.

Although not shown and described, other input devices and/or readers, such as for example, barcode readers and the like are contemplated.

Power manager 214 may be any microcontroller or integrated circuit that governs power functions of PoS device 200. Power manager 214 may include, for example, firmware, software, memory, a CPU, a CPU, input/output functions, timers to measure intervals of time, as well as analog to digital converters to measure the voltages of the main battery or power source of PoS device 200. In various embodiments, Power manager 214 remain active even when PoS device 200 is completely shut down, unused, and/or powered by the backup battery. Power manager 214 may be responsible for coordinating many functions, including, for example, monitoring power connections and battery charges, charging batteries when necessary, controlling power to other integrated circuits within PoS device 200 and/or other peripherals and/or readers, shutting down unnecessary system components when they are left idle, controlling sleep and power functions (on and off), managing the interface for built-in keypad and trackpads, and/or regulating a real-time clock (RTC).

Keypad 216 may any input device that includes a set of buttons arranged, for example, in a block or pad and may bear digits, symbols and/or alphabetical letters. Keypad 216 may be a hardware-based or mechanical-type keypad and/or implemented in software and displayed on, for example, a screen or touch screen to form a keypad. Keypad 216 may receive input from a user that pushed or otherwise activates one or more buttons on keypad 216 to provide input.

Audio interface 218 may be any device capable of providing audio signals from PoS device 200. For example, audio interface may be a speaker or speakers that may produce audio signals. In various embodiments, audio interface 218 may be integrated within PoS device 200. Audio interface 218 also may include components that are external to PoS device 200.

Touchscreen/display control 220 may be any device or controller that controls an electronic visual display. Touchscreen/display control 220 may allow a user to interact with PoS device 200 through simple or multi-touch gestures by touching a screen or display (e.g., display 222). Touchscreen/display control 220 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 220 may receive inputs from the touchscreen and process the received inputs. Touchscreen/display control 220 also may control the display on PoS device 200, thereby providing the graphical user interface on a display to a user of PoS device 200.

Display 222 may be any display suitable for a PoS device. For example, display 222 may be a TFT, LCD, LED or other display. Display 222 also may be a touchscreen display that for example allows a user to interact with PoS device 200 through simple or multi-touch gestures by touching a screen or display (e.g., display 222). Display 222 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 222 may receive inputs from control gestures provided by a user. Display 222 also may display images, thereby providing the graphical user interface to a user of PoS device 200.

Cash register/retail enterprise system 224 may me any device or devices that cooperate with PoS device 200 to process transactions. Cash register/retail enterprise system 224 may be coupled with other components of PoS device 200 via, for example, a data interface (e.g., data interface 206) as illustrated in FIG. 2. Cash register/retail enterprise system 224 also may be integrated into PoS device 200.

In various embodiments, cash register/retail enterprise system 224 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 224 may comprise an retail enterprise system and/or a customer relationship management system. Retail enterprise system 224 may enable retain enterprises to manage operations and performance across a retail operation (e.g., a bank branch operation, an auto sales operation, a big box retailer, and/or the like). Retail enterprise system 224 may be a stand-alone application in, for example, individual stores or branches, or may be interconnected via a network (e.g., a branch network). Retail enterprise system 224 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 224 also may include inventory control and tracking capabilities, reporting tools, customer management capabilities, employee management tools, and may integrate with other accounting software.

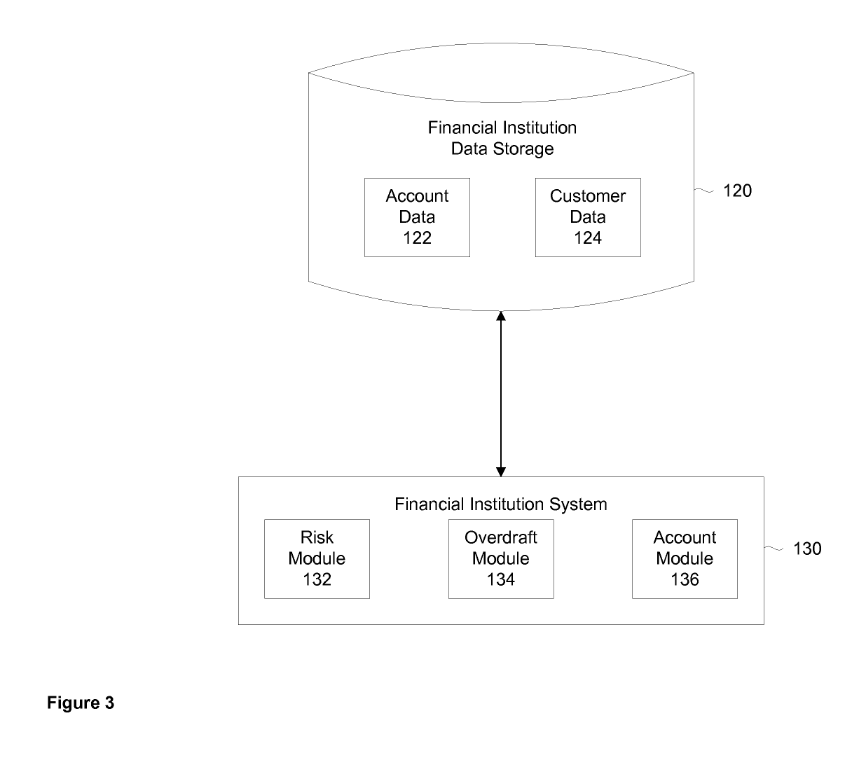

FIG. 3 illustrates a block diagram of hardware components of a system for determining overdraft protection according to a particular embodiment and specifically the components of a financial institution system 130 and financial institution data storage 120. Additionally, various components of the financial institution system 130 may alternatively reside on a third party system 140 as disclosed herein.

Financial institution system 130 may include a risk module 132 for calculating an overdraft risk score associated with a particular account and a specific customer, the customer being a customer associated with a customer system 150. The financial institution system 130 may further include an overdraft module 134 for determining an overdraft protection limit to associate with a calculated overdraft risk score. The overdraft module 134 may reside on a third party system 140, where the third party system 140 receives an overdraft risk score from a financial institution system 130 and then determines an overdraft protection limit to associate with the received overdraft risk score. When the overdraft module 134 resides on a third party system 140, the third party system 140 may transmit the determined overdraft protection to the financial institution system 150 from which the overdraft risk score originated. Once an overdraft protection limit is determined, the overdraft protection limit may be stored within an account module 136, where the overdraft protection limit may be associated with a particular customer account. The account module 136 may also monitor account data 122 and customer data 124 stored within a financial institution data storage 120 and may generate a trigger to transmit to a risk module 132 when account data 122 or customer data 124 is altered within the database 120.

Financial institution data storage 120 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, financial institution data storage 120 may be a database, such as an Oracle database, a Microsoft SQL Server database, a DB2 database, a MySQL database, a Sybase database, an object oriented database, a hierarchical database, or other database. Financial institution data storage 120 may utilize flat file structures for storage of data. As discussed herein, financial institution data storage 120 may include account data 122 and customer data 124. Account data 122 may include any, or a combination, of account type, account balance, account transaction details, and/or account debits and credits. Customer data 124 may include any, or a combination, of customer name, customer address, customer date of birth, customer social security number, customer employment status, customer employer name, customer income, customer residential status (e.g., whether a customer rents or owns), customer monthly mortgage or rental payments, customer marital status, and/or customer velocity of money rating.

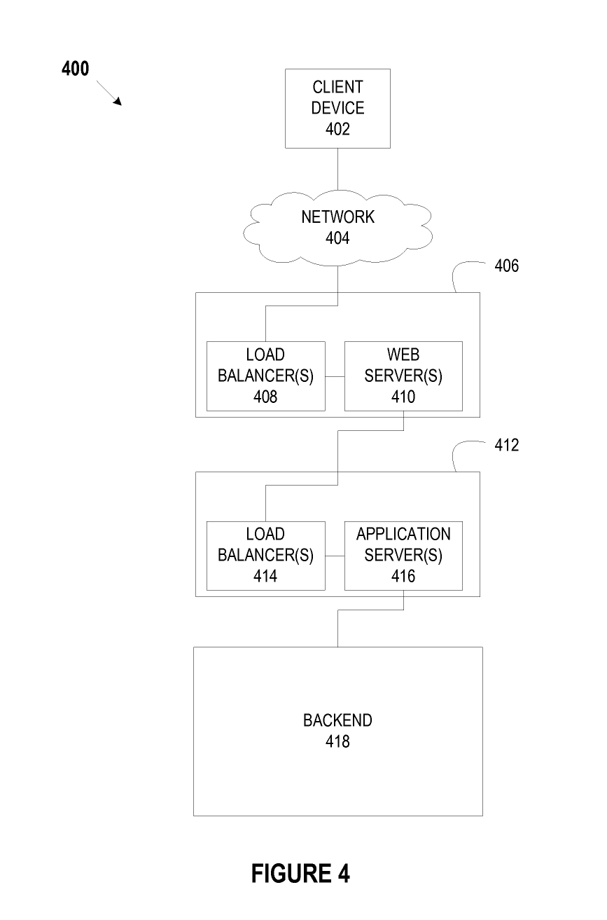

The components of financial institution 130 including financial institution data storage 120 may reside in, for example, the backend of a distributed system associated with a financial institution. FIG. 4 depicts an example system 400 that may enable a financial institution, for example, to provide network services (e.g., branch banking services) to its customers and/or branch associates. As shown in FIG. 4, system 400 may include a client device 402 (e.g., a front end system), a network 404, a front-end controlled domain 406, a back-end controlled domain 412, and a backend 418. Front-end controlled domain 406 may include one or more load balancers 408 and one or more web servers 410. Back-end controlled domain 412 may include one or more load balancers 414 and one or more application servers 416.

Client device 402 may be a network-enabled computer. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 400 may execute one or more software applications to enable, for example, network communications.

Client device 402 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 404 may be one or more of a wireless network, a wired network, or any combination of a wireless network and a wired network. For example, network 404 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 404 may include, without limitation, telephone lines, fiber optics, IEEE Ethernet 902.3, a wide area network (WAN), a local area network (LAN) or a global network such as the Internet. Also, network 404 may support an Internet network, a wireless communication network, a cellular network, or the like, or any combination thereof. Network 404 may further include one network, or any number of example types of networks mentioned above, operating as a stand-alone network or in cooperation with each other. Network 404 may utilize one or more protocols of one or more network elements to which they are communicatively couples. Network 404 may translate to or from other protocols to one or more protocols of network devices. Although network 404 is depicted as a single network, it should be appreciated that according to one or more embodiments, network 404 may comprise a plurality of interconnected networks, such as, for example, the Internet, a service provider's network, a cable television network, corporate networks, and home networks.

Front-end controlled domain 406 may be implemented to provide security for backend 418. Load balancer(s) 408 may distribute workloads across multiple computing resources, such as, for example computers, a computer cluster, network links, central processing units or disk drives. In various embodiments, load balancer(s) 410 may distribute workloads across, for example, web server(S) 416 and/or backend 418 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 408 may include software that monitoring the port where external clients, such as, for example, client device 402, connect to access various services of a financial institution, for example. Load balancer(s) 408 may forward requests to one of the application servers 416 and/or backend 418 servers, which may then reply to load balancer 408. This may allow load balancer(s) 408 to reply to client device 402 without client device 402 ever knowing about the internal separation of functions. It also may prevent client devices from contacting backend servers directly, which may have security benefits by hiding the structure of the internal network and preventing attacks on backend 418 or unrelated services running on other ports, for example.

A variety of scheduling algorithms may be used by load balancer(s) 408 to determine which backend server to send a request to. Simple algorithms may include, for example, random choice or round robin. Load balancers 408 also may account for additional factors, such as a server's reported load, recent response times, up/down status (determined by a monitoring poll of some kind), number of active connections, geographic location, capabilities, or how much traffic it has recently been assigned.

Load balancers 408 may be implemented in hardware and/or software. Load balancer(s) 408 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 410 may include hardware (e.g., one or more computers) and/or software (e.g., one or more applications) that deliver web content that can be accessed by, for example a client device (e.g., client device 402) through a network (e.g., network 404), such as the Internet. In various examples, web servers, may deliver web pages, relating to, for example, online banking applications and the like, to clients (e.g., client device 402). Web server(s) 410 may use, for example, a hypertext transfer protocol (HTTP or sHTTP) to communicate with client device 402. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 410 may respond with the content of that resource or an error message if unable to do so. The resource may be, for example a file on stored on backend 418. Web server(s) 410 also may enable or facilitate receiving content from client device 402 so client device 402 may be able to, for example, submit web forms, including uploading of files.

Web server(s) also may support server-side scripting using, for example, Active Server Pages (ASP), PHP, or other scripting languages. Accordingly, the behavior of web server(s) 410 can be scripted in separate files, while the actual server software remains unchanged.

Load balancers 414 may be similar to load balancers 408 as described above.

Application server(s) 416 may include hardware and/or software that is dedicated to the efficient execution of procedures (e.g., programs, routines, scripts) for supporting its applied applications. Application server(s) 416 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 416 may act as a set of components accessible to, for example, a financial institution or other entity implementing system 400 through an API defined by the platform itself. For Web applications, these components may be performed in, for example, the same running environment as web server(s) 410, and application servers 416 may support the construction of dynamic pages. Application server(s) 416 also may implement services, such as, for example, clustering, fail-over, and load-balancing. In various embodiments, where application server(s) 416 are Java application servers, the web server(s) 416 may behaves like an extended virtual machine for running applications, transparently handling connections to databases associated with backend 418 on one side, and, connections to the Web client (e.g., client device 402) on the other.

Backend 418 may include hardware and/or software that enables the backend services of, for example, a financial institution or other entity that maintains a distributes system similar to system 400. For example, backend 418 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 418 also may include branch sales and service event processing and reporting systems. Backend 418 may be associated with various databases, including account databases that maintain, for example, customer account information, product databases that maintain information about products and services available to customers, content databases that store content associated with, for example, a financial institution, and the like. Specifically, backend 418 may include the components shown and described in FIGS. 1, 3, and 6. Backend 418 also may be associated with one or more servers that enable the various services provided by system 400.

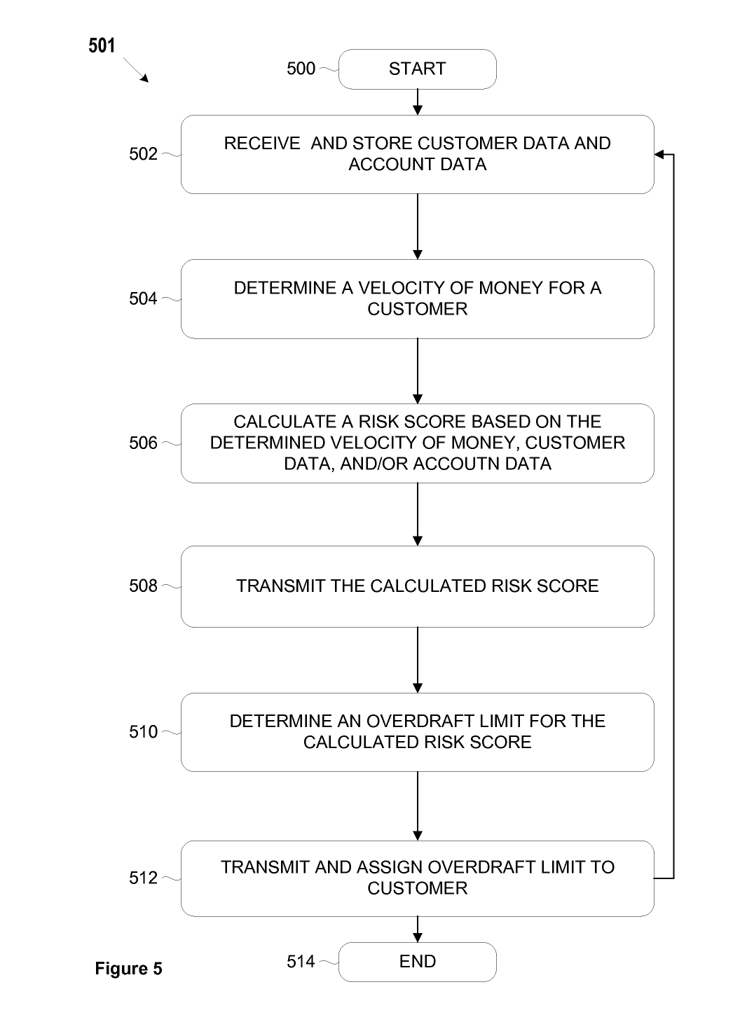

FIG. 5 is a flowchart illustrating a method 501 for determining and assigning an overdraft protection to a customer according to a particular embodiment. The method 501 illustrated in FIG. 5 is described herein in the context of FIGS. 1 and 3, however, as will be understood, other like systems may utilized to implement method 501. Method 501 begins at step 500. At step 502, a financial institution system 130 may receive customer data and account data and store the customer data and account data in financial institution data storage 120. At step 504, the financial institution system 130 account module 136 may determine a velocity of money based on the stored account data 122 and customer data 124. A velocity of money rating may be determined based on a statistical analysis of customer transaction and deposit patterns associated with an account. For example, where a customer transaction pattern is to spend deposited money the day after making a deposit, a customer may have a high velocity of money rating. If a customer transaction pattern is to incur transactions at a steady rate following a deposit, a customer may have a low velocity of money rating. The velocity of money rating may then be stored in the account data 122 for the associated account. At step 506, an overdraft risk score may be calculated at the financial institution system 130 based on the account data 122, which includes a velocity of money rating associated with the account, and/or the customer data 124.

Where a third party system is utilized 140 to determine an overdraft protection limit for the calculated risk score, the calculated risk score may be transmitted at step 508 to a third party system 140. At step 510, an overdraft module 134 may determine an overdraft limit for the calculated overdraft risk score. As discussed herein, the overdraft module 134 may reside at a financial institution system 130 or a third party system 140, depending on which system performs the overdraft protection limit determination.

The determination of an overdraft limit may be based on the calculated risk and/or the determined velocity of money. Additional variables that may be involved in determining a risk score and/or overdraft limit may include, for example, the average days that an account is in an overdraft state, the particular account type associated with the overdraft limit (e.g., a checking account, a savings account, etc.), the average customer balance, whether or not a customer maintains another account type with the same financial institution (e.g., a customer maintains a credit card account and a savings account with the same bank), the age of the account (e.g., whether the account is more or less than 60 days old), the total balance of all accounts for a particular customer, a ratio of debit transactions against all transactions, the age of the oldest account owned by a customer, if an account is currently at zero balance, the time since a last overdraft, a number of days an account is in past due status, the number of ACH transactions in a predetermined time period, a number of account holders, an average daily balance, a direct deposit amount, whether or not direct deposit has been active in a predetermined time period, a deposit amount, a returned check amount, and whether the customer maintains a loan product with the financial institution associated with the account. The decision of which variables to include in determining a risk score and/or overdraft limit may be based statistical significance, coefficient of variation and/or a p-value.

At step 512, the overdraft protection limit may be transmitted to the financial institution system 130 if a third party system 140 determined the overdraft protection limit, where the financial institution system 130 may use an account module 136 to associate the overdraft protection limit with a particular account. The method then ends at step 514.

Method 501 may repeat on a predetermined schedule, where a predetermined schedule may be, for example, every day, every week, or every month. The method may also repeat when a trigger signal is received at the financial institution system indicating that the method should be performed. A trigger signal may be generated at the account module 136. The account module 136 may also monitor the account data 122 and customer data 124 and detect any changes in the data. Changes in data may include, for example, the modification of customer data within the financial institution data storage and/or system, the modification of account data within the financial institution data storage and/or system, and/or the addition or deletion of an account associated with a customer within the financial institution data storage and/or system.

Additionally, the assignment of a new overdraft limit may be a batch process that occurs daily. This batch process may include only those accounts where a change in an overdraft limit has been detected. For example, a risk score and an overdraft limit may be calculated for each account on a daily basis. However, the process of updating each account and storing a new overdraft limit may be streamlined such that only accounts that have incurred a change in their overdraft limit are updated in data storage 120. Accordingly, overdraft module 134 may compare a newly determined overdraft limit with a previously determined overdraft limit and, where the newly determined overdraft limit equals the previously determined overdraft limit, the account may be filtered out as not needing to be updated in batch processing.

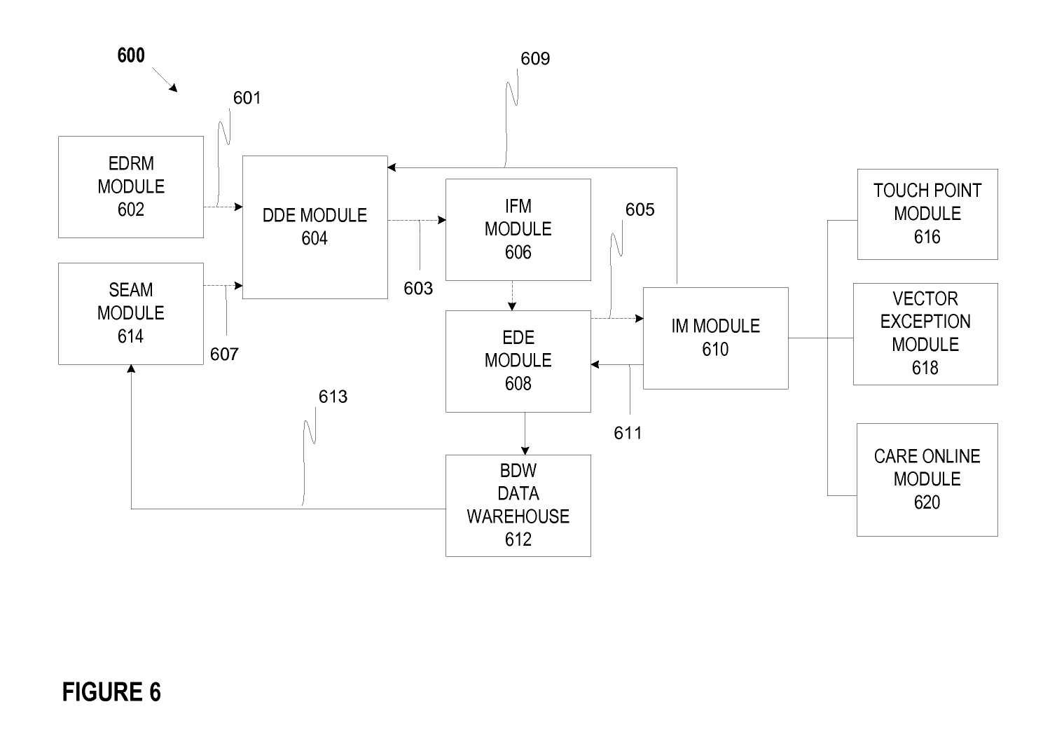

FIG. 6 illustrates a schematic drawing of a system 600 that may BE used to assign overdraft limits. System 600 may include, for example, an electronic records and data management (EDRM) module 602, a dynamic data exchange (DDE) module 604, an IFM module 606, an electronic data exchange (EDE) module 608, an information management (IM) module 610, a bank data warehouse 612, a SEAM module 614, a touchpoint module 616, a vector exception module 618, and a care online module 620. As shown in FIG. 6, the dashed arrows may represent model outputs in the overdraft limit assignment process and the solid arrows may represent inputs in the overdraft assignment limit process. For example, dashed line 601 may represent model outputs that may be segments to overdraft limits. These segments may be available with the latest updates at a particular time of day, such as, for example, 2 am. Dashed line 603 may represent the latest outputs, which may be out by a certain time of day, such as, for example, 7 pm. At that time, an IFM cycle may begin in IFM module 606. Dashed line 605 may represent an output which usually occurs at a certain time of day, such as, for example, 10 pm. Dashed line 607 may represent a new model output which may occur at a certain time of day, such as for example, 3:30 am. Solid line 609 may represent IM output file BAU. Solid line 611 may represent an IM output file. And solid line 613 may represent the next day feed for the model input. Also, system 600 may be implemented within a backend (e.g., backend 418) of a financial institution. IM module 610 may, for example, batch process model outputs at a certain time of day. Touchpoint module 616 may be configured configured to alter an opt in status when desired, display overdraft limits, display refunds requested and approved, and provide any notes that may be relevant to the overdraft assignment module. Touchpoint module 616 also may be configured to perform a touchpoint analysis on customers of a financial institution to better understand the various “touches” a customer has with the financial institution. Vendor exception module 618 may determine and store vendor exception types, provides an interface for manual approvals as well as automatic approvals on non-sufficient funds transactions, and provides a manual waiver on non-sufficient funding and overdraft fees. The operation of vendor exception module is further described in, for example, U.S. patent application Ser. No. ______, entitled “A System and Method For Processing Vector Exceptions”, filed on ______, the entire contents of which is incorporated herein by reference. Care online module 620 may be configured to process and store a pay none request. The overdraft limit assignment process module may interact with, receive inputs from, and provide outputs to the touchpoint module 616, the vendor exception module 618, and/or the care online module 620. The overdraft limit assignment process module makes a determination of an overdraft limit assignment and provides that determination to a financial institution system 130, a customer system 150, and/or a merchant system 160. Also, FIG. 6, DDE module 604 may filter out the accounts where a previous overdraft limit equals a newly calculated overdraft limit and send only those accounts that have a change in an overdraft limit to IFM module 606 for processing.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A system comprising:
a receiver that receives, via a network, financial account data and customer data associated with a customer;
a first database that stores the financial account data and the customer data;
a velocity of money processor that calculates a velocity of money score for the customer using the account data and customer data;
a risk processor that calculates an overdraft risk for the customer based on the account data, the customer data, and the velocity of money score;
an account module that associates an overdraft protection limit based on the overdraft risk with an account of the customer; and
a second database that stores the overdraft protection limit.

2. The system of claim 1, wherein the first database and the second database are the same.

3. The system of claim 1, wherein the first database and the second database are different databases.

4. The system of claim 1, wherein the risk processor calculates an overdraft risk on a predetermined schedule.

5. The system of claim 1, wherein the risk processor calculates an overdraft risk in response to a trigger signal.

6. The system of claim 5, wherein the trigger signal is a request for authorization received from a point of sale device.

7. The system of claim 1, wherein the velocity of money score represents how quickly the customer spends money after making a deposit.

8. The system of claim 1, wherein the velocity of money score is calculated by performing a statistical analysis on transaction data associated with the customer.

9. The system of claim 8, wherein the transaction data includes a transaction date and transaction amount.

10. The system of claim 8, wherein the velocity of money score is based on a touchpoint analysis associated with the customer.

11. A method comprising:
receiving, via a network financial account data and customer data associated with a customer;
storing the financial account data and the customer data in a first database;
calculating, using a velocity of money processor, a velocity of money score for the customer using the account data and customer data;
calculating, using a risk processor, an overdraft risk for the customer based on the account data, the customer data, and the velocity of money score;
associating in an account module an overdraft protection limit based on the overdraft risk with an account of the customer; and
storing the overdraft protection limit in a second database.

12. The method of claim 11, wherein the first database and the second database are the same.

13. The method of claim 11, wherein the first database and the second database are different databases.

14. The method of claim 11, further comprising calculating an overdraft risk on a predetermined schedule.

15. The method of claim 11, further comprising calculating an overdraft risk in response to a trigger signal.

16. The method of claim 15, wherein the trigger signal is a request for authorization received from a point of sale device.

17. The method of claim 11, wherein the velocity of money score represents how quickly the customer spends money after making a deposit.

18. The method of claim 11, further comprising calculating the velocity of money score is by performing a statistical analysis on transaction data associated with the customer.

19. The method of claim 18, wherein the transaction data includes a transaction date and transaction amount.

20. The method of claim 18, wherein the velocity of money score is based on a touchpoint analysis associated with the customer.
